(19) United States
(12) Patent Application Publication
(10) Pub. No.: US 2022/0293294 A1
(43) Pub. Date: Sep. 15, 2022

(54) CONDUCTIVE EPOXY FORMULATIONS

(71) Applicant: Cabot Corporation, Boston, MA (US)

(72) Inventors: Lang H. Nguyen, Lowell, MA (US); Tianqi Liu, Boxborough, MA (US); Zhangliang Gui, Shanghai (CN); Shi-lin Wang, Hubei Shiyan (CN)

(21) Appl. No.: 17/690,239

(22) Filed: Mar. 9, 2022

Related U.S. Application Data
(60) Provisional application No. 63/159,112, filed on Mar. 10, 2021.
(60) Provisional application No. 63/174,246, filed on Apr. 13, 2021.

(51) Int. Cl. H01B 1/24; C08K 3/04; C08J 3/21

(52) U.S. Cl. CPC H01B 1/24; C08K 3/041; C08J 3/212; C08K 2201/001; C08K 2201/011; C08J 2363/00

(57) ABSTRACT

An epoxy composition containing CNS-derived fragments provides conductivity and surface hardness. In one illustration, the epoxy composition includes carbon nanostructures, fragments of carbon nanostructures, fractured carbon nanotubes, elongated carbon strands, and/or dispersed carbon nanostructures dispersed in an epoxy resin. The epoxy composition may also include additional fillers or other additives.

### BACKGROUND OF THE INVENTION

This application claims priority from U.S. Ser. No. 63/159112, filed Mar. 10, 2021, and U.S. Ser. No. 63/174246, filed Apr. 13, 2021, the entire contents of both of which are incorporated herein by reference.

### FIELD OF THE INVENTION

This invention relates to conductive epoxy formulations, for example, coatings and encapsulants.

### DESCRIPTION OF THE RELATED ART

Epoxies are versatile polymers that are employed in a variety of applications, including adhesives, coatings and encapsulants. Inclusion of particles or fibers in epoxy composites can deliver a wide range of desirable properties, depending on the final application. For example, US20180177081 discloses the use of polymer encapsulated carbon nanostructures, from which the encapsulant has been removed, in combination with epoxy to produce electromagnetic shielding (EMI) materials. However, the removal of the encapsulant generates waste solvent and increases the number of processing steps to prepare an epoxy formulation. Therefore, it is desirable to produce a more sustainable carbon nanostructure-epoxy formulation in which improved dispersion and electrical performance can be achieved in a simplified process without the use of volatile solvents.

Storage of liquid petroleum products such as light oils and crude oil provides many opportunities for generation of static electricity, e.g., during flow, mixing, filtration, stirring, etc. Volatile species in the petroleum products can evaporate to generate a combustible vapor which can ignite if the accumulated static electricity discharges. The buildup of static charge is also problematic during the production of electronic devices which can be damaged by discharge. Thus, it is desirable to have a coating for storage tanks for liquid petroleum products and for flooring that can dissipate charge and that is also light colored to facilitate periodic inspection for flaws or damage.

### SUMMARY OF THE INVENTION

In one embodiment, an epoxy composition includes an epoxy resin and up to 2 wt % CNS-derived species. When the epoxy composition is evaluated according to Evaluation Method A, the resulting cured coating has a surface resistivity (ohm·sq) of at most 165x^{-5.5}, wherein x is the percentage of CNS-derived species by weight in the cured coating. The epoxy composition may include 1-2 wt % of CNS-derived material.

The CNS-derived material may include carbon nanostructures, fragments of carbon nanostructures, fractured carbon nanotubes, elongated CNS strands, dispersed CNSs, and any combinations thereof. The carbon nanostructures or fragments of carbon nanostructures include a plurality of multiwall carbon nanotubes that are crosslinked in a polymeric structure by being branched, interdigitated, entangled and/or sharing common walls. The fractured carbon nanotubes are derived from the carbon nanostructures and are branched and share common walls with one another. Elongated CNS strands are derived from the carbon nanostructures and include CNTs that have been displaced linearly with respect to one another, and dispersed CNS comprise exfoliated fractured CNTs that do not share common walls with one another.

The CNS derived species may be coated or in a mixture with a binder, which may be a dispersant. The weight of the binder relative to the weight of the coated CNS derived species may be within the range of from about 0.1% to about 10%. Observation of a microscopic image of the composition having 440 microns×380 microns or equivalent area may reveal no more than one fragment of a carbon nanostructure having a bundle width greater than 50 microns, where the composition is prepared for observation by diluting the mixture to a CNS-derived material loading of about 0.05% with additional uncured polymer and pressing a drop-sized aliquot between two glass microscope slides.

The epoxy resin may be a component of a one-component curable epoxy polymer system or a two-component curable epoxy polymer system. The epoxy composition may further include one or more of a diluent, a hardener, and a solvent. The epoxy composition may further include one or more additives selected from clays, talc, hydrophilic and hydrophobic fumed and precipitated silicas, metal carbonates, titanium dioxide, pigments, adhesion promoters, flow modifiers, leveling aids, and biocides.

In another embodiment, a method for preparing an epoxy composition includes combining carbon nanostructures with an epoxy resin to form a mixture and disperse the carbon nanostructures in the uncured polymer and generate CNS-derived material selected from fractured carbon nanotubes, elongated CNS strands, dispersed CNS, and any combination thereof. The carbon nanostructures or fragments of carbon nanostructures include a plurality of multiwall carbon nanotubes that are crosslinked in a polymeric structure by being branched, interdigitated, entangled and/or sharing common walls. The fractured carbon nanotubes are derived from the carbon nanostructures and are branched and share common walls with one another. Elongated CNS strands are derived from the carbon nanostructures and include CNTs that have been displaced linearly with respect to one another, and dispersed CNS comprise exfoliated fractured CNTs that do not share common walls with one another. Combining includes dispersing the carbon nanostructures until observation of a microscopic image of the mixture having 40 microns×780 microns or equivalent area reveals no more than one fragment of a carbon nanostructure having a bundle width greater than 50 microns, wherein the mixture is prepared for observation by diluting the mixture to a CNS-derived material loading of about 0.05% with additional uncured polymer and pressing a drop-sized aliquot between two glass microscope slides.

The epoxy composition may include 1-2 wt % of CNS-derived material. The CNS derived species may be coated or in a mixture with a binder, which may be a dispersant. The weight of the binder relative to the weight of the coated CNS derived species may be within the range of from about 0.1% to about 10%.

The epoxy resin may be a component of a one-component curable epoxy polymer system or a two-component curable epoxy polymer system. The epoxy composition may further include one or more of a diluent, a hardener, and a solvent. The epoxy composition may further include one or more additives selected from clays, talc, hydrophilic and hydrophobic fumed and precipitated silicas, metal carbonates, titanium dioxide, pigments, adhesion promoters, flow modifiers, leveling aids, and biocides.

The composition is prepared using carbon nanostructures (CNSs, singular CNS), a term that refers herein to a plurality of carbon nanotubes (CNTs) that that are crosslinked in a polymeric structure by being branched, e.g., in a dendrimeric fashion, interdigitated, entangled and/or sharing common walls with one another. Operations conducted to prepare the compositions described herein can generate CNS fragments and/or fractured CNTs. Fragments of CNSs are derived from CNSs and, like the larger CNS, include a plurality of CNTs that are crosslinked in a polymeric structure by being branched, interdigitated, entangled and/or sharing common walls. Fractured CNTs are derived from CNSs, are branched and share common walls with one another. Without being held to any specific interpretation, it is believed that the fragments of CNSs and/or the fractured CNTs are derived or generated from CNSs during one or more processing steps (e.g., operations undertaken to disperse or mix the initial CNSs into a carrier) involved in preparing the systems described herein.

Highly entangled CNSs are macroscopic in size and can be considered to have a carbon nanotube (CNT) as a base monomer unit of its polymeric structure. For many CNTs in the CNS structure, at least a portion of a CNT sidewall is shared with another CNT. While it is generally understood that every carbon nanotube in the CNS need not necessarily be branched, crosslinked, or share common walls with other CNTs, at least a portion of the CNTs in the carbon nanostructure can be interdigitated with one another and/or with branched, crosslinked, or common-wall-sharing carbon nanotubes in the remainder of the carbon nanostructure.

The invention presents many other advantages. As already noted, for example, the CNSs employed can generate fragments of CNSs (including partially fragmented CNSs) and/or fractured CNTs. These structures can bring about improved connectivity between one another, thereby enhancing electrical conductivity. The use of CNSs can result in the formation of a flexible conductive network with good coverage within the epoxy material at low loading, reducing their impact on color properties.

It is to be understood that both the foregoing general description and the following detailed description are exemplary and explanatory only and are intended to provide further explanation of the present invention, as claimed.

### BRIEF DESCRIPTION OF THE DRAWING

The invention is described with reference to the several figures of the drawing, in which,

FIGS. 1A and 1B are diagrams illustrating differences between a Y-shaped MWCNT, not in or derived from a carbon nanostructure (FIG. 1A), and a branched MWCNT (FIG. 1B) in a carbon nanostructure.

FIGS. 2A and 2B are TEM images showing features characterizing multiwall carbon nanotubes found in carbon nanostructures.

FIG. 3A is an illustrative depiction of a carbon nanostructure flake material after isolation of the carbon nanostructure from a growth substrate;

FIG. 3B is a SEM image of an illustrative carbon nanostructure obtained as a flake material;

FIG. 4 is a series of optical micrographs of a 0.5 wt % dispersion in epoxy at various states of dispersion (scale bar=200 microns).

FIG. 5 is an optical micrograph showing a well dispersed dispersion of CNS in epoxy let down to 0.05 wt % (scale bar=100 microns)

FIG. 6 is an optical micrograph showing a incompletely dispersed dispersion of CNS in epoxy hardener let down to 0.1 wt % (scale bar=100 microns).

FIG. 7 is a graph showing the Konig hardness of various epoxy coatings (43 micron dry coating thickness) containing CNS derived fragments.

FIG. 8 is a graph showing the surface resistivity of epoxy coatings containing various amounts of CNS derived fragments (triangle), MWCNT (circle), and SWCNT (square).

FIG. 9 is a graph showing the color (L*) of epoxy coatings containing various amounts of CNS derived fragments (triangle), MWCNT (circle), and SWCNT (square).

### DETAILED DESCRIPTION OF THE INVENTION

An epoxy composition may an epoxy resin and up to 2 wt % CNS-derived species, wherein, when the epoxy composition is evaluated according to Evaluation Method A, the resulting cured coating has a surface resistivity (ohm·sq) of at most 165x^{-5.5}, wherein x is the percentage of CNS-derived species by weight in the cured coating. In Evaluation Method A, a 2 mil coating of the epoxy composition is cast on a polyethylene terephthalate film and allowed to cure for four days at room temperature.

The epoxy compositions provided herein may be prepared with any kind of epoxy resin. As used herein, an epoxy resin is a reactive prepolymer composition that contains epoxide groups that are available to cross-link the epoxy resin either by homopolymerization or by reacting with reactive curatives or hardeners. The prepolymer may include epoxy-terminated oligomers and/or molecules with more than two epoxide groups. Suitable epoxy resins include bisphenol-based epoxies, e.g., bisphenol A or F diglycidyl either, epoxy novolak resins, brominated epoxy resins, cycloaliphatic epoxides, epoxidized fatty acids, aromatic glycidyl amines, hydrogenated bisphenol epoxy resins, epoxy acrylates, and other epoxy resins known to those of skill in the art. Mixtures of these may be employed as well. Suitable commercial epoxy resins may be obtained from companies such as Huntsman, Olin, Hexion, and Momentive Specialty Chemicals, CVC Thermoset Specialties, Gabriel, and Allnex.

Difunctional or higher functional epoxy resins may also be employed in combination with a diluent. Exemplary diluents include mono-, di-, tri-, and higher functional epoxidized compounds. Suitable diluents include C4-C14 branched and unbranched aliphatic glycidyl ethers, aralkyl glcidyl ethers such as cresyl glycidyl ether and p-tert-butylphenyl glycidyl ether, trimethylol propane triglycidyl ether, 1,4-butanediol diglycidyl ether, neopenyl glycol diglycidyl ether, cyclohexane dimethanol diglycidyl ether, polyalkylene glycol diglycidyl ethers, resorcinol diglycidyl ether, pentaerythritol polyglycidyl ether, castor oil triglycidyl ether, cycloaliphatic epoxide resins, sorbitol polyglycidyl ether, N,N-diglycidyl aniline, triglycidyl-p-aminophenol, and other diluents known to those of skill in the art. Suitable diluents may be obtained from the epoxy suppliers mentioned above.

Any epoxy curative known to those of skill in the art may be employed. Exemplary cross-linking curatives, often termed “hardeners”, include polyamines such as polyalkylene amines and polyoxyalkylene amines, aliphatic and cycloaliphatic amines, fatty acid modified amines, polyamides, aromatic amines, polyacids, polymercaptans, polyphenols, anhydrides, especially cyclic anhydrides, aliphatic amine adducts, acrylic and methacrylic resins, aminoplast and phenoplast resins, imidazoles, phenolic novolac resins, cyanate esters, dihydrazides and isocyanate compounds. Epoxy resins may also be cured by addition of cationic or anionic polymerization initiators, including but not limited to Lewis acids such as boron tri-fluoride monoethylamine, dicyandiamine, and metal hydroxides. Hardeners are available in both liquid and powdered form, and the selection of appropriate hardeners is well known to those of skill in the art. In certain embodiments, liquid hardeners will be preferred for coating applications, while powdered hardeners may be preferred for adhesive and/or encapsulant applications. Exemplary hardeners and polymerization initiators may be obtained from companies such as Evonik, and the epoxy suppliers mentioned above.

As known in the art, carbon nanotubes (CNT or CNTs plural) are carbonaceous materials that include at least one sheet of sp²-hybridized carbon atoms bonded to each other to form a honey-comb lattice that forms a cylindrical or tubular structure. The carbon nanotubes can be single-walled carbon nanotubes (SWCNTs) or multi-walled carbon nanotubes (MWCNTs). SWCNTs can be thought of as an allotrope of sp²-hybridized carbon similar to fullerenes. The structure is a cylindrical tube including six-membered carbon rings. Analogous MWCNTs, on the other hand, have several tubes in concentric cylinders. The number of these concentric walls may vary, e.g., from 2 to 25 or more. Typically, the diameter of MWNTs may be 10 nm or more, in comparison to 0.7 to 2.0 nm for typical SWNTs.

In many of the CNSs used in various embodiments, the CNTs are MWCNTs, having, for instance, at least two coaxial carbon nanotubes. The number of walls present, as determined, for example, by transmission electron microscopy (TEM), at a magnification sufficient for analyzing the number of wall in a particular case, can be within the range of from 2 to 30 or so, for example: 4 to 30; 6 to 30; 8 to 30; 10 to 30; 12 to 30; 14 to 30; 16 to 30; 18 to 30; 20 to 30; 22 to 30; 24 to 30; 26 to 30; 28 to 30; or 2 to 28; 4 to 28; 6 to 28; 8 to 28; 10 to 28; 12 to 28; 14 to 28; 16 to 28; 18 to 28; 20 to 28; 22 to 28; 24 to 28; 26 to 28; or 2 to 26; 4 to 26; 6 to 26; 8 to 26; 10 to 26; 12 to 26; 14 to 26; 16 to 26; 18 to 26; 20 to 26; 22 to 26; 24 to 26; or 2 to 24; 4 to 24; 6 to 24; 8 to 24; 10 to 24; 12 to 24; 14 to 24; 16 to 24; 18 to 24; 20 to 24; 22 to 24; or 2 to 22; 4 to 22; 6 to 22; 8 to 22; 10 to 22; 12 to 22; 14 to 22; 16 to 22; 18 to 22; 20 to 22; or 2 to 20; 4 to 20; 6 to 20; 8 to 20; 10 to 20; 12 to 20; 14 to 20; 16 to 20; 18 to 20; or 2 to 18; 4 to 18; 6 to 18; 8 to 18; 10 to 18; 12 to 18; 14 to 18; 16 to 18; or 2 to 16; 4 to 16; 6 to 16; 8 to 16; 10 to 16; 12 to 16; 14 to 16; or 2 to 14; 4 to 14; 6 to 14; 8 to 14; 10 to 14; 12 to 14; or 2 to 12; 4 to 12; 6 to 12; 8 to 12; 10 to 12; or 2 to 10; 4 to 10; 6 to 10; 8 to 10; or 2 to 8; 4 to 8; 6 to 8; or 2 to 6; 4 to 6; or 2 to 4.

Since a CNS is a polymeric, highly branched and crosslinked network of CNTs, at least some of the chemistry observed with individualized CNTs may also be carried out on the CNS. In addition, some of the attractive properties often associated with using CNTs also are displayed in materials that incorporate CNSs. These include, for example, electrical conductivity, attractive physical properties including maintaining or enabling good tensile strength when integrated into a silicone-based composition, thermal stability (sometimes comparable to that of diamond crystals or in-plane graphite sheets) and/or chemical stability, to name a few.

However, as used herein, the term “CNS” is not a synonym for individualized, un-entangled structures such as “monomeric” fullerenes (the term “fullerene” broadly referring to an allotrope of carbon in the form of a hollow sphere, ellipsoid, tube, e.g., a carbon nanotube, and other shapes). In fact, many embodiments of the invention highlight differences and advantages observed or anticipated with the use of CNSs as opposed to the use of their CNTs building blocks. Without wishing to be held to a particular interpretation, it is believed that the combination of branching, crosslinking, and wall sharing among the carbon nanotubes in a CNS reduces or minimizes the van der Waals forces that are often problematic when using individual carbon nanotubes in a similar manner, especially when it is desirable to prevent agglomeration.

In addition, or alternatively to performance attributes, CNTs that are part of or are derived from a CNS can be characterized by a number of features, at least some of which can be relied upon to distinguish them from other nanomaterials, such as, for instance, ordinary CNTs (namely CNTs that are not derived from CNSs and can be provided as individualized, pristine or fresh CNTs).

In many cases, a CNT present in or derived from a CNS has a typical diameter of 100 nanometers (nm) or less, such as, for example, within the range of from about 5 to about 100 nm, e.g., within the range of from about 10 to about 75, from about 10 to about 50, from about 10 to about 30, from about 10 to about 20 nm.

In specific embodiments, at least one of the CNTs has a length that is equal to or greater than 2 microns, as determined by SEM. For example, at least one of the CNTs will have a length within a range of from 2 to 2.25 microns; from 2 to 2.5 microns; from 2 to 2.75 microns; from 2 to 3.0 microns; from 2 to 3.5 microns; from 2 to 4.0 microns; or from 2.25 to 2.5 microns; from 2.25 to 2.75 microns; from 2.25 to 3 microns; from 2.25 to 3.5 microns; from 2.25 to 4 microns; or from 2.5 to 2.75 microns; from 2.5 to 3 microns; from 2.5 to 3.5 microns; from 2.5 to 4 microns; or from 3 to 3.5 microns; from 3 to 4 microns; of from 3.5 to 4 microns or higher. In some embodiments, more than one, e.g., a portion such as a fraction of at least about 0.1%, at least about 1%, at least about 10%, at least about 15%, at least about 20%, at least about 25%, at least about 30%, at least about 35%, at least about 40, at least about 45%, at least about 50% or even more than one half, of the CNTs, as determined by SEM, can have a length greater than 2 microns, e.g., within the ranges specified above.

For many CNTs in a CNS, at least a portion of a CNT sidewall is shared with another CNT. While it is generally understood that every carbon nanotube in the CNS need not necessarily be branched, crosslinked, or share common walls with other CNTs, at least a portion of the CNTs in the carbon nanostructure can be interdigitated with one another and/or with branched, crosslinked, or common-wall carbon nanotubes in the remainder of the carbon nanostructure.

The morphology of CNTs present in a CNS, in a fragment of a CNS or in a fractured CNT derived from a CNS will often be characterized by a high aspect ratio, with lengths typically more than 100 times the diameter, and in certain cases much higher. For instance, in a CNS (or CNS fragment), the length to diameter aspect ratio of CNTs can be within a range of from about 200 to about 1000, such as, for instance, from 200 to 300; from 200 to 400; from 200 to 500; from 200 to 600; from 200 to 700; from 200 to 800; from 200 to 900; or from 300 to 400; from 300 to 500; from 300 to 600; from 300 to 700; from 300 to 800; from 300 to 900; from 300 to 1000; or from 400 to 500; from 400 to 600; from 400 to 700; from 400 to 800; from 400 to 900; from 400 to 1000; or from 500 to 600; from 500 to 700; from 500 to 800; from 500 to 900; from 500 to 1000;or from 600 to 700; from 600 to 800; from 600 to 900; from 600 to 1000; from 700 to 800; from 700 to 900; from 700 to 1000; or from 800 to 900; from 800 to 1000; or from 900 to 1000.

It has been found that in CNSs, as well as in structures derived from CNSs (CNS-derived particles, e.g., fragments of CNSs or in fractured CNTs) at least one of the CNTs is characterized by a certain “branch density”. As used herein, the term “branch” refers to a feature in which a single carbon nanotube diverges into multiple (two or more), connected multiwall carbon nanotubes. One embodiment has a branch density according to which, along a two-micrometer length of the carbon nanostructure, there are at least two branches, as determined by SEM. Three or more branches also can occur.

In addition, or in the alternative, the number of walls observed at the area (point) of branching in a CNS, fragment of CNSs or fractured CNTs differ from one side of the branching (e.g., before the branching point) to the other side of this area (e.g., after or past the branching point). Such a change in the number of walls, also referred to herein as an “asymmetry” in the number of walls, is not observed with ordinary Y-shaped CNTs (where the same number of walls is observed in both the area before and the area past the branching point).

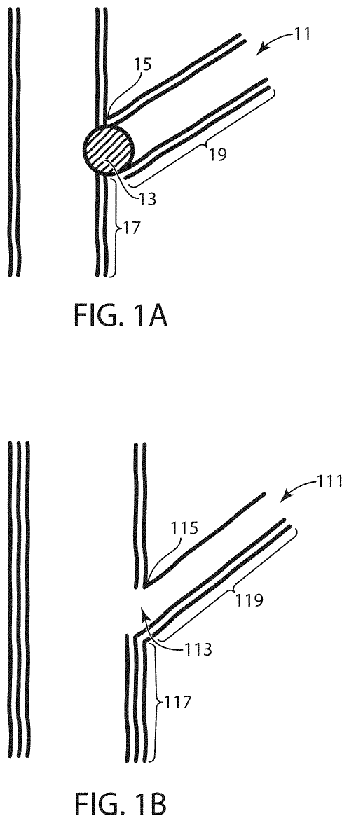

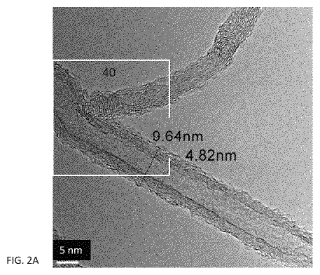

Diagrams illustrating these features are provided in FIGS. 1A and 1B. Shown in FIG. 1A, is an exemplary Y-shaped CNT 11 that is not derived from a CNS. Y-shaped CNT 11 includes catalyst particle 13 at or near branching point 15. Areas 17 and 19 are located, respectively, before and after the branching point 15. In the case of a Y-shaped CNT such as Y-shaped CNT 11, both areas 17 and 19 are characterized by the same number of walls, i.e., two walls in the drawing.

In contrast, in a CNS (FIG. 1B), a CNT building block 111, that branches at branching point 115, does not include a catalyst particle at or near this point, as seen at catalyst devoid region 113. Furthermore, the number of walls present in region 117, located before, prior (or on a first side of) branching point 115 is different from the number of walls in region 119 (which is located past, after or on the other side relative to branching point 115. In more detail, the three-walled feature found in region 117 is not carried through to region 119 (which in the diagram of FIG. 1B has only two walls), giving rise to the asymmetry mentioned above.

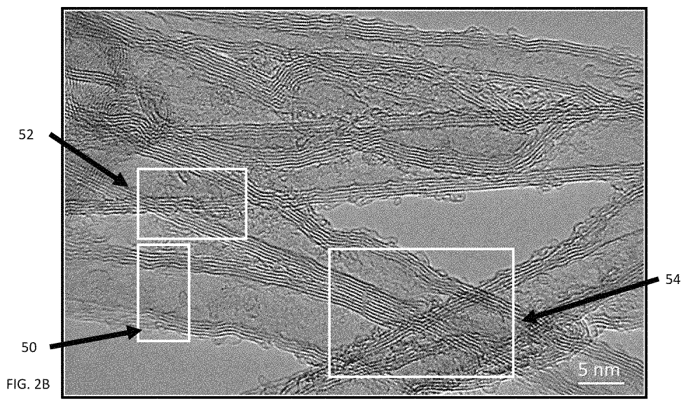

These features are highlighted in the TEM images of FIGS. 2A and 2B.

In more detail, the CNS branching in TEM region 40 of FIG. 2A shows the absence of any catalyst particle. In the TEM of FIG. 2B, first channel 50 and second channel 52 point to the asymmetry in the number of walls featured in branched CNSs, while arrow 54 points to a region displaying wall sharing.

One, more, or all these attributes can be encountered in the coating compositions described herein.

In some embodiments, the CNS is present as part of an entangled and/or interlinked network of CNSs. Such an interlinked network can contain bridges between CNSs.

Suitable techniques for preparing CNSs are described, for example, in U.S. Patent Application Publication No. 2014/0093728 A1, published on Apr. 3, 2014, U.S. Pat. Nos. 8,784,937B2; 9,005,755B2; 9,107,292B2; and 9,447,259B2. The entire contents of these documents are incorporated herein by this reference.

As described in these documents, a CNS can be grown on a suitable substrate, for example on a catalyst-treated fiber material. The product can be a fiber-containing CNS material. In some cases, the CNSs is separated from the substrate to form flakes.

As seen in US 2014/0093728A1 a carbon nanostructure obtained as a flake material (i.e., a discrete particle having finite dimensions) exists as a three-dimensional microstructure due to the entanglement and crosslinking of its highly aligned carbon nanotubes. The aligned morphology is reflective of the formation of the carbon nanotubes on a growth substrate under rapid carbon nanotube growth conditions (e.g., several microns per second, such as about 2 microns per second to about 10 microns per second), thereby inducing substantially perpendicular carbon nanotube growth from the growth substrate. Without being bound by any theory or mechanism, it is believed that the rapid rate of carbon nanotube growth on the growth substrate can contribute, at least in part, to the complex structural morphology of the carbon nanostructure. In addition, the bulk density of the CNS can be modulated to some degree by adjusting the carbon nanostructure growth conditions, including, for example, by changing the concentration of transition metal nanoparticle catalyst particles that are disposed on the growth substrate to initiate carbon nanotube growth.

The flakes can be further processed, e.g., by cutting or fluffing (operations that can involve mechanical ball milling, grinding, blending, etc.), chemical processes, or any combination thereof.

In some embodiments, the CNSs employed are “coated”, also referred to herein as “sized” or “encapsulated” CNSs. In a typical sizing process, the coating is applied onto the CNTs that form the CNS. The sizing process can form a partial or a complete coating that is non-covalently bonded to the CNTs and, in some cases, can act as a binder. In addition, or in the alternative, the size can be applied to already formed CNSs in a post-coating (or encapsulation) process. With sizes that have binding properties, CNSs can be formed into larger structures, granules or pellets, for example. In other embodiments the granules or pellets are formed independently of the function of the sizing.

Coating amounts can vary. For instance, relative to the overall weight of the coated CNS material, the coating can be within the range of from about 0.1 weight % to about 10 weight % (e.g., within the range, by weight, of from about 0.1% to about 0.5%; from about 0.5% to about 1%; from about 1% to about 1.5%; from about 1.5% to about 2%; from about 2% to about 2.5%; from about 2.5% to about 3%; from about 3% to about 3.5%; from about 3.5% to about 4%; from about 4% to about 4.5%; from about 4.5% to about 5%; from about 5% to about 5.5%; from about 5.5% to about 6%; from about 6% to about 6.5%; from about 6.5% to about 7%; from about 7% to about 7.5%; from about 7.5% to about 8%; from about 8% to about 8.5%; from about 8.5% to about 9%; from about 9% to about 9.5%; or from about 9.5% to about 10%.

In many cases, controlling the amount of coating (or sizing) reduces or minimizes undesirable effects on the properties of the CNS material itself. Low coating levels, for instance, are more likely to preserve electrical properties brought about by the incorporation of CNSs or CNS-derived (e.g., CNS fragments of fractured CNTs) materials in a coating composition.

Various types of coatings can be selected. In many cases, sizing solutions commonly used in coating carbon fibers or glass fibers could also be utilized to coat CNSs. Specific examples of coating materials include but are not limited to fluorinated polymers such as poly(vinyldifluoroethylene) (PVDF), poly(vinyldifluoroethylene-co -hexafluoropropylene) (PVDF-HFP), poly(tetrafluoroethylene) (PTFE), polyimides, and water-soluble binders, such as poly(ethylene) oxide, polyvinyl-alcohol (PVA), cellulose, carboxymethylcellulose (CMC), starch, hydroxypropylcellulose, regenerated cellulose, polyvinyl pyrrolidone (PVP), and copolymers and mixtures thereof In many implementations, the CNSs used are treated with a polyurethane (PU), a thermoplastic polyurethane (TPU), or with polyethylene glycol (PEG).

Polymers such as, for instance, epoxy, polyester, vinylester, polyetherimide, polyetherketoneketone, polyphthalamide, polyetherketone, polyetheretherketone, polyimide, phenol-formaldehyde, bismaleimide, acrylonitrile-butadiene styrene (ABS), polycarbonate, polyethyleneimine, polyurethane, polyvinyl chloride, polystyrene, polyolefins, polypropylenes, polyethylenes, polytetrafluoroethylene, elastomers such as, for example, polyisoprene, polybutadiene, butyl rubber, nitrile rubber, ethylene-vinyl acetate polymers, silicone polymers, and fluorosilicone polymers, combinations thereof, or other polymers or polymeric blends can also be used in some cases. In order to enhance electrical conductivity, conductive polymers such as, for instance, polyanilines, polypyrroles and polythiophenes can also be used.

Some implementations utilize coating materials that can assist in stabilizing a CNS dispersion in a solvent. In one example, the coating is selected to facilitate and/or stabilize dispersing CNSs in a vehicle produced by combining the desired resin for the coating with a desired solvent together with optional dispersant. Any suitable combination of the resins and solvents provided above may be employed. In another example, the coating material is the same as, similar to, or compatible with a dispersant or thickener employed when processing CNSs.

Suitable dispersants include: an acrylate-based dispersant; a polyurethane acrylic copolymer dispersant; a polyacetal-based dispersant; an acrylic dispersant such as an acrylic acid, methyl methacrylate, alkyl(C1 to C10)acrylate, vinyl acrylate or 2-ethylhexyl acrylate; a polycarbonate-based dispersant; a styrene-based dispersant such as styrene or alpha methyl styrene; a polyester-based dispersant; a polyphenylene ether-based dispersant; a polyolefin-based dispersant; an acrylonitrile-butadiene-styrene copolymer dispersant; a polyarylate-based dispersant; a polyamide-based dispersant; a polyamide imide-based dispersant; a polyaryl sulfone-based dispersant; a polyether imide-based dispersant; a polyether sulfone-based dispersant; a polyphenylene sulfide-based dispersant; a polyimide-based dispersant; a polyether ketone-based dispersant; a poly benzoxazol-based dispersant; a poly oxadiazole-based dispersant; a poly benzothiazole-based dispersant; a poly benzimidazole-based dispersant; a polypyridine-based dispersant; a polytriazole-based dispersant; a polypyrrolidine-based dispersant; a poly dibenzofuran-based dispersant; a polysulfone-based dispersant; a polyurea-based dispersant; a polyurethane-based dispersant; a polyphosphazene-based dispersant; and dispersants based on copolymers or mixtures of any of the above.

Many embodiments described herein use CNS-materials that have a 97% or higher CNT purity. Often, the CNSs used herein require no further additives to counteract Van der Waals forces.

CNSs can be provided in the form of a loose particulate material (as CNS flakes, granules, pellets, etc., for example) or in formulations that also include a liquid medium, e.g., dispersions, slurries, pastes, or in other forms. In many implementations, the CNSs employed are separated from their growth substrate.

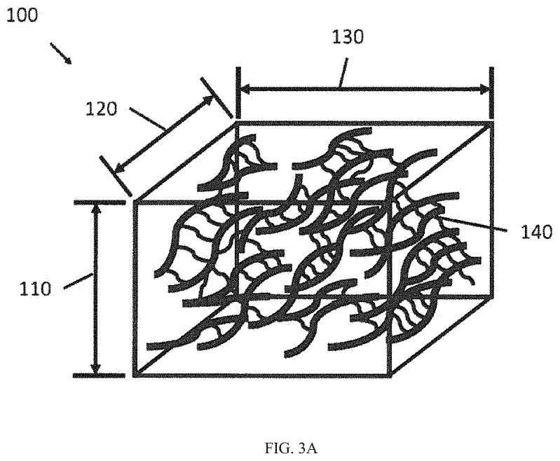

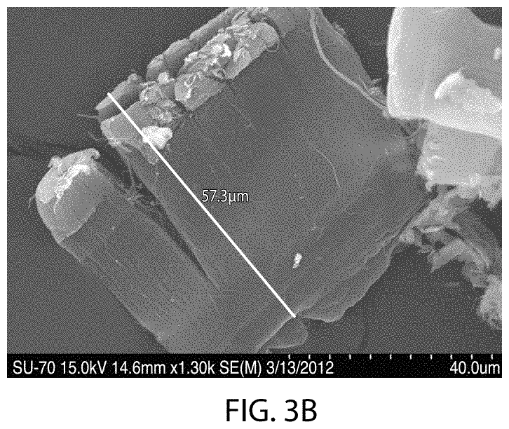

In some embodiments, the CNSs are provided in the form of a flake material after being removed from the growth substrate upon which the carbon nanostructures are initially formed. As used herein, the term “flake material” refers to a discrete particle having finite dimensions. Shown in FIG. 3A, for instance, is an illustrative depiction of a CNS flake material after isolation of the CNS from a growth substrate. Flake structure 100 can have first dimension 110 that is in a range from about 1 nm to about 35 microns thick, particularly about 1 nm to about 500 nm thick, including any value in between and any fraction thereof. Flake structure 100 can have second dimension 120 that is in a range from about 1 micron to about 750 microns tall, including any value in between and any fraction thereof. Flake structure 100 can have third dimension 130 that can be in a range from about 1 micron to about 750 microns, including any value in between and any fraction thereof. Two or all of dimensions 110, 120 and 130 can be the same or different.

For example, in some embodiments, second dimension 120 and third dimension 130 can be, independently, on the order of about 1 micron to about 10 microns, or about 10 microns to about 100 microns, or about 100 microns to about 250 microns, from about 250 to about 500 microns, or from about 500 microns to about 750 microns.

CNTs within the CNS can vary in length from about 10 nanometers (nm) to about 750 microns (μm), or higher. Thus, the CNTs can be from 10 nm to 100 nm, from 10 nm to 500 nm; from 10 nm to 750 nm; from 10 nm to 1 micron; from 10 nm to 1.25 micron; from 10 nm to 1.5 micron; from 10 nm to 1.75 micron; from 10 nm to 2 micron; or from 100 nm to 500 nm, from 100 nm to 750 nm; from 100 nm to 1 micron; from 100 to 1.25 micron; from 100 to 1.5 micron; from 100 to 1.75 micron from 100 to 2 microns; from 500 nm to 750 nm; from 500 nm to 1 micron; from 500 nm to 1 micron; from 500 nm to 1.25 micron; from 500 nm to 1.5 micron; from 500 nm to 1.75 micron; from 500 nm to 2 micron; from 750 nm to 1 micron; from 750 nm to 1.25 micron; from 750 nm to 1.5 micron; from 750 nm to 1.75 microns; from 750 nm to 2 microns; from 1 micron to 1.25 micron; from 1.0 micron to 1.5 micron; from 1 micron to 1.75 micron; from 1 micron to 2 microns; or from 1.25 micron to 1.5 micron; from 1.25 micron to 1.75 micron; from 1 micron to 2 microns; or from 1.5 to 1.75 micron; from 1.5 to 2 micron; or from 1.75 to 2 microns. In some embodiments, at least one of the CNTs has a length that is equal to or greater than 2 microns, as determined by SEM, for example, up to 4 microns or greater.

Shown in FIG. 3B is a SEM image of an illustrative carbon nanostructure obtained as a flake material. The carbon nanostructure shown in FIG. 3B exists as a three-dimensional microstructure due to the entanglement and crosslinking of its highly aligned carbon nanotubes. The aligned morphology is reflective of the formation of the carbon nanotubes on a growth substrate under rapid carbon nanotube growth conditions (e.g., several microns per second, such as about 2 microns per second to about 10 microns per second), thereby inducing substantially perpendicular carbon nanotube growth from the growth substrate. Without being bound by any theory or mechanism, it is believed that the rapid rate of carbon nanotube growth on the growth substrate can contribute, at least in part, to the complex structural morphology of the carbon nanostructure. In addition, the bulk density of the carbon nanostructure can be modulated to some degree by adjusting the carbon nanostructure growth conditions, including, for example, by changing the concentration of transition metal nanoparticle catalyst particles that are disposed on the growth substrate to initiate carbon nanotube growth.

A flake structure can include a webbed network of carbon nanotubes in the form of a carbon nanotube polymer (i.e., a “carbon nanopolymer”) having a molecular weight in a range from about 15,000 g/mol to about 150,000 g/mol, including all values in between and any fraction thereof. In some cases, the upper end of the molecular weight range can be even higher, including about 200,000 g/mol, about 500,000 g/mol, or about 1,000,000 g/mol. The higher molecular weights can be associated with carbon nanostructures that are dimensionally long. The molecular weight can also be a function of the predominant carbon nanotube diameter and number of carbon nanotube walls present within the carbon nanostructure. The crosslinking density of the carbon nanostructure can range between about 2 mol/cm³ to about 80 mol/cm³. Typically, the crosslinking density is a function of the carbon nanostructure growth density on the surface of the growth substrate, the carbon nanostructure growth conditions and so forth. It should be noted that the typical CNS structure, containing many, many CNTs held in an open web-like arrangement, removes Van der Waals forces or diminishes their effect. This structure can be exfoliated more easily, which makes many additional steps of separating them or breaking them into branched structures unique and different from ordinary CNTs.

With a web-like morphology, carbon nanostructures can have relatively low bulk densities, for example, from about 0.005 g/cm3 to about 0.1 g/cm3 or from about 0.01 g/cm3 to about 0.05 g/cm3. As-produced carbon nanostructures can have an initial bulk density ranging from about 0.003 g/cm3 to about 0.015 g/cm3. Further consolidation and/or coating to produce a carbon nanostructure flake material or like morphology can raise the bulk density to a range from about 0.1 g/cm3 to about 0.15 g/cm3. In some embodiments, optional further modification of the carbon nanostructure can be conducted to further alter the bulk density and/or another property of the carbon nanostructure. In some embodiments, the bulk density of the carbon nanostructure can be further modified by forming a coating on the carbon nanotubes of the carbon nanostructure and/or infiltrating the interior of the carbon nanostructure with various materials. Coating the carbon nanotubes and/or infiltrating the interior of the carbon nanostructure can further tailor the properties of the carbon nanostructure for use in various applications. Moreover, forming a coating on the carbon nanotubes can desirably facilitate the handling of the carbon nanostructure. Further compaction can raise the bulk density to an upper limit of about 1 g/cm3, with chemical modifications to the carbon nanostructure raising the bulk density to an upper limit of about 1.2 g/cm3.

In addition to the flakes described above, the CNS material can be provided as granules, pellets, or in other forms of loose particulate material, having a typical particle size within the range of from about 1 mm to about 1 cm, for example, from about 0.5 mm to about 1 mm, from about 1 mm to about 2 mm, from about 2 mm to about 3 mm, from about 3 mm to about 4 mm, from about 4 mm to about 5 mm, from about 5 mm to about 6 mm, from about 6 mm to about 7 mm, from about 7 mm to about 8 mm, from about 8 mm to about 9 mm or from about 9 mm to about 10 mm.

Commercially, examples of CNS materials that can be utilized are those developed by Applied Nanostructured Solutions, LLC (ANS) (Massachusetts, United States).

In preferred embodiments to produce coatings, CNSs are provided in an epoxy masterbatch having 1-2 wt % CNS derived species. Techniques used to prepare the epoxy masterbatch can generate CNS-derived species as “CNS fragments” and/or “fractured CNTs” that become distributed (e.g., homogeneously) in individualized form throughout the masterbatch. Except for their reduced sizes, CNS fragments (a term that also includes partially fragmented CNSs) generally share the properties of intact CNS and can be identified by electron microscopy and other techniques, as described above. Fractured CNTs can be formed when crosslinks between CNTs within the CNS are broken, under applied shear, for example. Derived (generated or prepared) from CNSs, fractured CNTs are branched and share common walls with one another.

In other embodiments, pellets, granules, flakes or other forms of loose CNS particles are first dispersed in an epoxy, generating CNS fragments (including partially fragmented CNSs) and/or fractured CNTs. The masterbatch can be prepared from a starting material such as, for example, uncoated, PU- or PEG-coated CNS, or CNSs having any other polymeric binder coating.

In some situations, an initial CNS is broken into smaller CNS units or fragments. Except for their reduced sizes, these fragments generally share the properties of intact CNS and can be identified by electron microscopy and other techniques, as described above.

Also possible are changes in the initial nanostructure morphology of the CNS. For example, applied shear can break crosslinks between CNTs within a CNS to form CNTs that typically will be dispersed as individual CNTs in the coating composition. It is found that structural features of branching and shared walls are retained for many of these CNTs, even after the crosslinks are removed. CNTs that are derived (prepared) from CNSs and retain structural features of CNT branching and shared walls are referred to herein as “fractured” CNTs. These species are capable of imparting improved interconnectivity (between CNT units), resulting in better conductivity at lower concentrations.

Thus, in comparison to coating compositions that employ ordinary, individualized CNTs, e.g., in pristine form, coating compositions described herein will often include fractured CNTs. These fractured CNTs can readily be differentiated from ordinary carbon nanotubes through standard carbon nanotube analytical techniques, such as SEM, for example. It is further noted that not every CNT encountered needs to be branched and share common walls; rather it is a plurality of fractured CNTs, that, as a whole, will possess these features.

The CNSs used herein can be identified and/or characterized by various techniques. Electron microscopy, including techniques such as transmission electron microscopy (TEM) and scanning electron microscopy (SEM), for example, can provide information about features such as the frequency of specific number of walls present, branching, the absence of catalyst particles, etc. See, e.g., FIGS. 2A-2B.

Raman spectroscopy can point to bands associated with impurities. For example, a D-band (around 1350 cm⁻¹) is associated with amorphous carbon; a G band (around 1580 cm⁻¹) is associated with crystalline graphite or CNTs). A G′ band (around 2700 cm⁻¹) is expected to occur at about 2× the frequency of the D band. In some cases, it may be possible to discriminate between CNS and CNT structures by thermogravimetric analysis (TGA).

Carbon nanostructures are preferably combined with epoxies to form highly dispersed mixtures. Any method known to those of skill in the art for combining particulate fillers with epoxy may be used. For example, devices such as planetary mixers, roll mills, Brabender mixers, Banbury mixers, and others known to those of skill in the art for use with epoxies may be employed. The amount of CNS in the epoxy may be adjusted to achieve the desired color and conductivity of the final epoxy composition. Likewise, the amount of CNS or other fillers in the epoxy may be adjusted to enhance chemical or abrasion resistance or promote other mechanical props in adhesives or encapsulants. Compositions may include as much as 5 wt % CNS-derived particles. For example, coating compositions may include 0.05 to 1 or 2% CNS-derived particles, while encapsulants or adhesives may include greater proportions of CNS-derived particles.

Dispersion may be evaluated by pressing a droplet-sized amount of material between two microscope slides and observing the material in a light microscope. At higher loadings, the CNS-filled material may be opaque. It may be necessary to let down the material, e.g., to a loading of about 0.05 wt %, to permit observation under the microscope. In certain embodiments, observation of an optical microscopic image of a coating composition having 440 micron×380 micron or equivalent area may reveal no more than one fragment of a carbon nanostructure having a bundle width greater than 50 microns, wherein the coating composition is prepared for observation by diluting the coating composition to a CNS loading of no more than 0.05% with additional uncured epoxy and pressing a drop-sized aliquot between two glass microscope slides.

CNS-filled epoxy compositions may also include additional fillers known to those of skill in the art for use in epoxy composites. Exemplary additives include fillers such as clays, talc, hydrophilic and hydrophobic fumed and precipitated silicas, and metal carbonates such as calcium carbonate. Additionally, adhesion promoters, flow modifiers, leveling aids, and biocides can be added. Additional pigments such as titanium oxide may also be employed. A dispersant such as those discussed above in connection with CNS coatings may be added. The epoxy composition may further include a solvent and/or a diluent. Preferred diluents have a low molecular weight (e.g., at most 1000 cps) and include reactive functional groups, e.g., hydroxyl, acrylate, maleimide, or epoxide, that can react or polymerize with the epoxy resin. The low molecular weight helps prevent viscosity buildup in the epoxy composition, but the diluent is incorporated into the polymerized epoxy during polymerization. Exemplary solvents include but are not limited to ketones such as acetone, ethyl methyl ketone, methyl isobutyl ketone, and cyclopentanone; aromatic hydrocarbons such as toluene, xylene, and methoxybenzene; glycol ethers such as dipropylene glycol dimethyl ether, dipropylene glycol diethyl ether, and propylene glycol monomethyl ether; esters such as ethyl lactate, ethyl acetate, butyl acetate, methyl-3-methoxy propionate, carbitol acetate, propylene glycol monomethyl ether acetate, and γ-butyrolactone; alcohols such as methanol and ethanol; aliphatic hydrocarbons such as octane and decane; and petroleum solvents such as petroleum ether, petroleum naphtha, hydrogenated petroleum naphtha and solvent naphtha.

Epoxy coatings prepared with CNS may be used in electrostatic dissipation applications such as flooring, e.g., concrete primers, coatings, and sealants, anti-corrosion primers for metals, tile grout, sealants, and adhesives, linings for tanks and containers, electronic devices, packaging for electronic devices, and pipe linings. Such coatings may be especially advantageous for dissipating static charge in storage tanks for liquid petroleum products and other fluids that generate explosive volatile organic compounds. At higher loadings (lower resistivity), epoxy coatings containing CNS may also be used to provide shielding from electromagnetic interference (EMI). The epoxy formulations provided herein may also be used for adhesives and encapsulants for circuit boards and chips and for protecting aerospace structures.

The present invention will be further clarified by the following examples which are intended to be only exemplary in nature.

### EXAMPLES

### Example 1

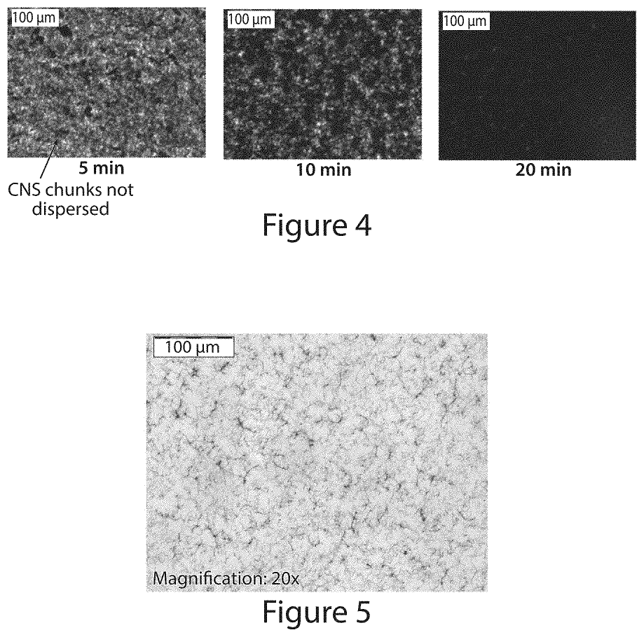

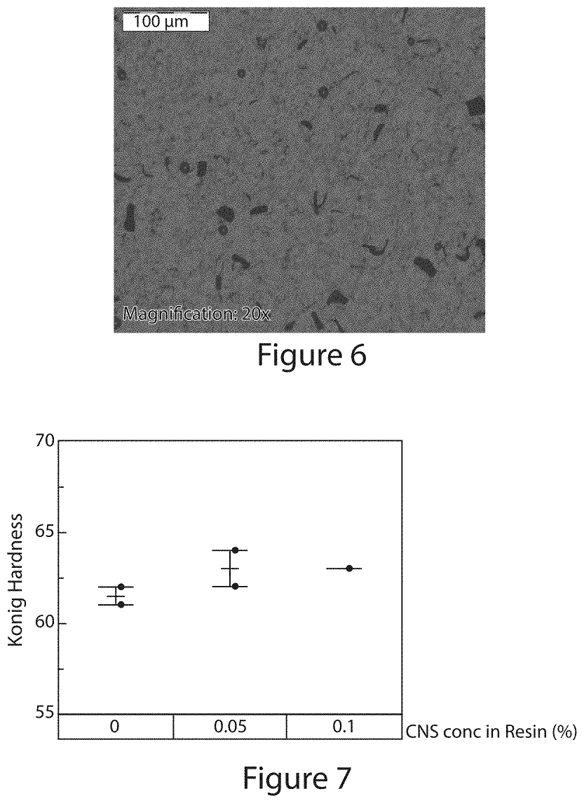

A 0.5 wt % CNS-epoxy stock was prepared by mixing 0.25 g of CNS in 49.75 g of Beckopox EP147w (Allnex) in a 100 mL container. The mixture was premixed by a FlackTek SpeedMixer® for two minutes at 2000 rpm in order to wet the CNS into the epoxy matrix. More extensive mixing was done with the help of four 1.5 cm diameter cylindrical ceramic beads at 2350 rpm at 5-minute intervals until microscope images (200× total magnification) showed no existence of CNS chunks (FIG. 4), then two more mixing cycles were performed to finish the dispersing step. Close examination of the quality of CNS dispersion in epoxy was conducted by diluting the CNS in epoxy stock with the original epoxy to either 0.05 wt % or 0.1 wt % with the speedmixer for 1 min at 1500 rpm. A drop of the diluted epoxy pressed between two microscope slides was observed in a light microscope. FIG. 5 shows a well-dispersed sample which was let down to 0.05 wt %. For contrast, FIG. 6 shows an incompletely dispersed sample which was let down to 0.1 wt %. A higher concentration (0.8 wt % CNS) epoxy stock formulation was prepared using the same method and a mixture of 40 g EP147w epoxy and 10 g Heloxy 61 butyl glycidyl ether diluent (Miller Stephenson) and an appropriate amount of CNS.

Coating formulations were prepared according to the formulations in Table 1 below by mixing the appropriate CNS-epoxy stock with (if used) additional EP147w epoxy in a FlackTek Speedmixer for 30 s at 1500 rpm, followed by either Beckopox EH623w/80WA (EH623) hardener (80% active, Allnex) or Beckopox EH637 hardener (59% active, Allnex), which was mixed in for two min at 3500 rpm. Any additional solvent (dipropylene glycol dimethyl ether) was then added and mixed for an additional minute at 3500 rpm. The resulting coating formulation was drawn down on either 5 mil PET transparent films or cold rolled steel panels with 3-mil, 2-mil, and 1-mil wet drawdown bars (BYK Chemie) and cured for four days at room temperature. Final CNS loading was calculated based on the solid and volatile components of the formulation.

TABLE 1

| | Formulation (g) | | | | | |
|---|---|---|---|---|---|---|
| Final CNS % | 0.5% | 0.8% | | | | |
| in the coating | CNS | CNS | | | | |
| (dry basis) | stock | stock | EP147w | EH 623 | EH 637 | solvent |
| 0.05 | 1.8 | | 8.2 | 10 | | 12 |
| 0.1 | 3.6 | | 6.4 | 10 | | 12 |
| 0.278 | 10 | | | 10 | | 12 |
| 0.618 | | 15 | | | 7.5 | 0 |

Surface resistivity was measured (four or five measurements in randomly chosen locations) on coated PET films using a four point probe connected to a Keithley 2410-C meter and is shown in Table 2. The comparative sample was prepared by combining 10 g each of the 0.5 CNS-epoxy stock and the 0.5% CNS-hardener stock for two min at 3500 rpm in a FlackTek Speedmixer, followed by 14 g dipropylene glycol dimethyl ether, which was mixed for an additional minute at 3500 rpm. This sample had a final CNS loading of 0.5.

TABLE 2
Surface Resistivity of Coating (ohm/sq)

| Coating | Final CNS % in the coating (dry basis) | | | |
|---|---|---|---|---|
| thickness (mil) | 0.05 | 0.1 | 0.278 | 0.618 |
| 1 | 1.80E+07 | 9.80E+06 | 5.96E+04 | 2.41E+03 |
| 2 | 1.83E+07 | 4.18E+06 | 3.66E+04 | 1.90E+03 |
| 3 | 1.83E+07 | 3.46E+06 | 3.10E+04 | 9.30E+02 |

Konig hardness was measured with a BYK-Gardner Konig hardness tester according to the manufacturer's instructions and were performed in duplicate on films drawn down on steel substrates at 3-mil wet thickness (FIG. 7).

Epoxy coatings were drawn down on cold rolled steel panels with a 3-mil drawdown bar (˜43 micron dry thickness) for color measurement. The color measurement was performed with a Hunter Labscan XE spectrophotometer from HunterLab Inc. The gloss measurements were done on a gloss meter produced by BYK. (Table 3).

TABLE 3

| CNS concentration | L* | a | b | Gloss (20°) | Gloss (60°) |
|---|---|---|---|---|---|
| 0 | 40.5 | −0.55 | 0.13 | 103 | 106 |
| 0.05% | 24.88 | −0.04 | 2.54 | 83 | 102 |
| 0.10% | 14.23 | 0.21 | 3.93 | 76 | 100 |

### Example 2

Epoxy millbases were prepared with MWCNT (CNTs4, Cabot Performance Materials, Zhuhai, China), SWCNT (Tuball CNT from OCSiAl), and carbon nanostructures produced according to U.S. Pat. No. 9,133,031. For SWCNT and CNS, millbases were prepared as follows. 45.0 g Cardura E10 fatty acid glycidyl ester (Momentive, CAS 26761-45-5) and 2.5 g Dispersogen TC130 dispersant (Clariant GmbH) were charged into a 100 mL plastic can and mixed at 2000 rpm for 2 min with a FlackTek SpeedMixer® DAC 600 mixer, following which 2.5 g SWCNT or CNS were added to the plastic can and mixed for an additional 2 min at 2000 rpm. The mixture was then transferred to a three-roll mill and processed for 20 passes. For MWCNT, the same process was used but with 40.0 g Cardura E10 glycidyl ester, 5.0 g Dispersogen TC130 dispersant, and 5.0 g MWCNT. A white millbase were prepared with following process and recipe. 17.0 g propylene glycol methyl ether acetate (PGMEA), 17.0 g butyl acetate and 6.0 g DISPERBYK®-161 dispersant (BYK Chemie) were charged into a tin can and stirred at 1500 rpm for 15 min with a Dispermat CV-SIP mixer. While maintaining stirring, 60.0 g Ti-Pure® R960 titania was added, following which the stir rate was increased to 2000 rpm and the mixture stirred an additional 15 min. The titania dispersion was loaded into a paint can with 150 g of 1 mm zirconium beads. The paint can were allowed to grind for one hour in a Lau Model DAS 200 Disperser and passed through a 200-mesh filter to separate the beads and millbase dispersion. Letdowns were prepared as specified in Tables 4 and 5 by mixing the Component A formulation with an equal mass of 1 mm zirconia beads for 10 min in a paint shaker. The Component A formulations were evaluated for Hegman grind. Coating formulations were prepared by combining Component A and Component B and mixing at 2000 rpm for 2 min with a FlackTek SpeedMixer® DAC 600 mixer.

Coatings were prepared on BYK-O-CHART panels using 120 microns draw down wires and allowed to air dry overnight. Surface resistivity was measured using a Keithley model 6517B electrometer fitted with Keithley 8009 test fixtures. Color measurements were performed on an X-Rite SP64, hand-held spectrophotometer in the CIE L*a*b* colorimetric system while excluding the specular reflectance mode.

TABLE 4
CNS or SWCNT Letdown Formulations (g)

| | 0.05 wt % | 0.1 wt % | 0.2 wt % |
|---|---|---|---|
| | Letdown | Letdown | Letdown |
| Component A | | | |
| Epikote 828 resin | 20.00 | 20.00 | 20.00 |
| Butyl Acetate | 6.00 | 5.78 | 5.35 |
| PGMEA | 6.00 | 5.78 | 5.35 |
| BYK ®-346 surfactant | 0.10 | 0.10 | 0.10 |
| TiO₂ Dispersion (60%) | 17.50 | 17.50 | 17.50 |
| 5% CNS or SWCNT | 0.41 | 0.85 | 1.70 |
| Millbase | | | |
| Component B | | | |
| Aradur ® 2973 Hardener | 10.18 | 10.38 | 10.77 |

Epikote 828 epoxy resin from Hexion
BYK-346 surfactant from BYK-Chemie
Aradur ® 2973 hardener from Huntsman

TABLE 5
MWCNT Letdown Formulations (g)

| | 0.2 wt % | 0.4 wt % | 0.8 wt % |
|---|---|---|---|
| | Letdown | Letdown | Letdown |
| Component A | | | |
| Epikote 828 resin | 20.00 | 20.00 | 20.00 |
| Butyl Acetate | 5.78 | 5.33 | 4.35 |
| PGMEA | 5.78 | 5.33 | 4.35 |
| BYK ®-346 dispersant | 0.10 | 0.10 | 0.10 |
| TiO₂ Dispersion (60%) | 17.50 | 17.50 | 17.50 |
| 10% MWCNT Millbase | 0.85 | 1.75 | 3.70 |
| Component B | | | |
| Aradur ® 2973 Hardener | 5.17 | 10.70 | 11.48 |

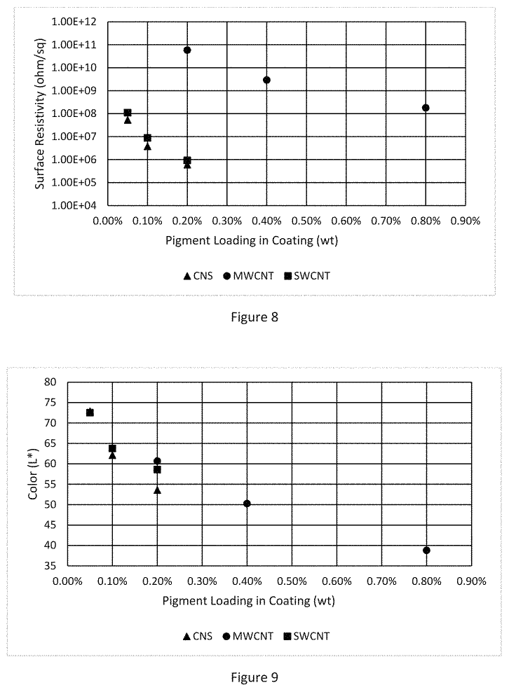

Performance data are shown in Table 6 below and in FIGS. 8 and 9. The fineness data show that the CNS exhibited better dispersion than the SWCNTs. While the MWCNTs exhibited the best dispersion, the resistivity was much lower for both the CNS and the SWCNTs, allowing conductivity to be achieved at much lower loading levels. Such lower loading levels also deliver lighter color (higher L*).

TABLE 6

| | Loading | Hegman | | | | Surface |
|---|---|---|---|---|---|---|
| | in Dry | Grind | | | | Resistivity |
| Pigment | Coating | (μm) | L* | a* | b* | (ohm/sq) |
| CNS | 0.05% | 80 | 73 | −1.11 | −0.95 | 5.3E+07 |
| | 0.10% | 90 | 62 | −0.91 | −0.17 | 3.8E+06 |
| | 0.20% | 100 | 54 | −0.99 | −0.75 | 6.0E+05 |
| MWCNT | 0.20% | 30 | 61 | −1.35 | −2.96 | 5.8E+10 |
| | 0.40% | 45 | 50 | −1.17 | −2.32 | 2.9E+09 |
| | 0.80% | 50 | 39 | −1.19 | −2.15 | 1.8E+08 |
| SWCNT | 0.05% | 100 | 73 | −1.74 | −0.48 | 1.1E+08 |
| | 0.10% | 100 | 64 | −1.92 | −0.68 | 8.8E+06 |
| | 0.20% | 100 | 59 | −2.12 | −1.86 | 9.2E+05 |

The foregoing description of preferred embodiments of the present invention has been presented for the purposes of illustration and description. It is not intended to be exhaustive or to limit the invention to the precise form disclosed. Modifications and variations are possible in light of the above teachings, or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. An epoxy composition comprising an epoxy resin and up to 2 wt % CNS-derived species, wherein, when the epoxy composition is evaluated according to Evaluation Method A, the resulting cured coating has a surface resistivity (ohm·sq) of at most 165x^{-5.5}, wherein x is the percentage of CNS-derived species by weight in the cured coating.

2. The epoxy composition of claim 1, wherein the composition comprises 1-2 wt % of CNS-derived material.

3. The epoxy composition of claim 1, wherein the CNS-derived material comprises carbon nanostructures, fragments of carbon nanostructures, fractured carbon nanotubes, elongated CNS strands, dispersed CNSs, and any combinations thereof, wherein
wherein the carbon nanostructures or fragments of carbon nanostructures include a plurality of multiwall carbon nanotubes that are crosslinked in a polymeric structure by being branched, interdigitated, entangled and/or sharing common walls,
wherein the fractured carbon nanotubes are derived from the carbon nanostructures and are branched and share common walls with one another,
wherein elongated CNS strands are derived from the carbon nanostructures and include CNTs that have been displaced linearly with respect to one another, and
wherein the dispersed CNS comprise exfoliated fractured CNTs that do not share common walls with one another.

4. The epoxy composition of claim 1, wherein the CNS derived species are coated or in a mixture with a binder.

5. The epoxy composition of claim 4, wherein the binder is a dispersant.

6. The epoxy composition of claim 4, wherein the weight of the binder relative to the weight of the coated CNS derived species is within the range of from about 0.1% to about 10%.

7. The epoxy composition of claim 1, wherein observation of a microscopic image of the composition having 440 microns×380 microns or equivalent area reveals no more than one fragment of a carbon nanostructure having a bundle width greater than 50 microns, wherein the composition is prepared for observation by diluting the mixture to a CNS-derived material loading of about 0.05% with additional uncured polymer and pressing a drop-sized aliquot between two glass microscope slides.

8. The epoxy composition of claim 1, wherein the epoxy resin is a component of a one-component curable epoxy polymer system or a two-component curable epoxy polymer system.

9. The epoxy composition of claim 1, further comprising one or more of a diluent, a hardener, and a solvent.

10. The epoxy composition of claim 1, further comprising one or more additives selected from clays, talc, hydrophilic and hydrophobic fumed and precipitated silicas, metal carbonates, titanium dioxide, pigments, adhesion promoters, flow modifiers, leveling aids, and biocides.

11. A method for preparing an epoxy composition, comprising:
combining carbon nanostructures with an epoxy resin to form a mixture and disperse the carbon nanostructures in the uncured polymer and generate CNS-derived material selected from fractured carbon nanotubes, elongated CNS strands, dispersed CNS, and any combination thereof;
wherein the carbon nanostructures include a plurality of multiwall carbon nanotubes that are crosslinked in a polymeric structure by being branched, interdigitated, entangled and/or sharing common walls,
wherein the fractured carbon nanotubes are derived from the carbon nanostructures and are branched and share common walls with one another,
wherein elongated CNS strands are derived from the carbon nanostructures and include CNTs that have been displaced linearly with respect to one another,
wherein the dispersed CNS comprise exfoliated fractured CNTs that do not share common walls with one another, and
combining comprises dispersing the carbon nanostructures until observation of a microscopic image of the mixture having 40 microns×780 microns or equivalent area reveals no more than one fragment of a carbon nanostructure having a bundle width greater than 50 microns, wherein the mixture is prepared for observation by diluting the mixture to a CNS-derived material loading of about 0.05% with additional uncured polymer and pressing a drop-sized aliquot between two glass microscope slides.

12. The method of claim 11, wherein the epoxy composition comprises 1-2 wt % of CNS-derived material.

13. The method of claim 11, wherein the CNS derived species are coated or in a mixture with a binder.

14. The method of claim 13, wherein the binder is a dispersant.

15. The method of claim 13, wherein the weight of the binder relative to the weight of the coated CNS derived species is within the range of from about 0.1% to about 10%.

16. The method of claim 11, wherein the epoxy resin is a component of a one-component curable epoxy polymer system or a two-component curable epoxy polymer system.

17. The method of claim 11, further comprising including one or more of a diluent, a hardener, an a solvent in the epoxy composition.

18. The method of claim 11, further comprising including one or more additives selected from clays, talc, hydrophilic and hydrophobic fumed and precipitated silicas, metal carbonates, titanium dioxide, pigments, adhesion promoters, flow modifiers, leveling aids, and biocides in the epoxy composition.
